(19) United States
(12) Patent Application Publication
(10) Pub. No.: US 2020/0018241 A1
(43) Pub. Date: Jan. 16, 2020

(54) ADJUSTING DEVICE AND METHOD FOR ADJUSTING A GUIDE GRID OF A TURBOMACHINE

(71) Applicant: MTU Aero Engines AG, München (DE)

(72) Inventor: Alexander Boeck, Kottgeisering (DE)

(73) Assignee: MTU Aero Engines AG, München (DE)

(21) Appl. No.: 16/505,815

(22) Filed: Jul. 9, 2019

(30) Foreign Application Priority Data
Jul. 11, 2018 (DE) 10 2018 211 535.4

(51) Int. Cl. F02C 9/22; F01D 17/04; F04D 29/56

(52) U.S. Cl. CPC F02C 9/22; F04D 29/563; F01D 17/04

(57) ABSTRACT

The present invention relates to an adjusting device for adjusting guide vanes of a guide vane cascade of a turbomachine, in particular of a turbine stage or a compressor stage of a gas turbine, wherein the adjusting device comprises a coupling ring for coupling the guide vanes and at least two actuators for rotating the coupling ring, said actuators being connected to the coupling ring, wherein at least one of these actuators has a disconnection coupling.

### BACKGROUND OF THE INVENTION

The present invention relates to an adjusting device for adjusting guide vanes of a guide vane cascade of a turbomachine, in particular of a turbine stage or a compressor stage of a gas turbine; a guide vane cascade for a turbomachine, in particular a gas turbine, having the adjusting device; a turbomachine, in particular a gas turbine, having the guide vane cascade; and a method for adjusting guide vanes of the guide vane cascade; as well as a control for carrying out the method.

From EP 3 101 279 A1 is known an adjusting device for adjusting guide vanes of a guide vane cascade of a turbomachine with two actuators, each of which has two redundant motors and a differential drive that adds up the input speeds of the two motors to produce an output speed of a differential drive that adjusts the guide vanes. If one motor of one actuator fails, the latter is shut down by a brake.

### SUMMARY OF THE INVENTION

An object of one embodiment of the present invention is to improve the adjusting of guide vanes of a guide vane cascade of a turbomachine.

This object is achieved by an adjusting device as well as a method of the present invention. A guide vane cascade or a turbomachine having (at least) one adjusting device and a control for carrying out a method are discussed herein. Advantageous embodiments of the invention are discussed in detail below.

According to one embodiment of the present invention, an adjusting device for adjusting guide vanes of a guide vane cascade of a turbomachine, in particular of a turbine stage or a compressor stage of a gas turbine, has a coupling ring to which, in one embodiment, the guide vanes are (each) coupled by a vane lever mechanism, or which is provided for this purpose, in particular is equipped or will be used for this purpose; and at least two actuators, in a preferred embodiment at least three actuators, in a particularly preferred enhancement four or more actuators, which, in one embodiment, are each connected to the coupling ring via an actuator lever mechanism and (together) rotate the coupling ring, in order to adjust the guide vanes, or which are provided for this purpose, in particular are equipped or will be used for this purpose.

In one embodiment, an adjusting load can be advantageously distributed by at least two actuators.

In one embodiment, an advantageous centering, in particular a spoke centering, of the coupling ring can be realized by at least three actuators.

In one embodiment, advantageously, a static overdetermination, in particular a static overdetermined (spoke) centering, of the coupling ring can be realized by three or four, and particularly by more than four actuators, and thus a failure of one of the actuators can be detected in a particularly advantageous manner.

In one embodiment, the actuators are equidistant over a circumference around the (main) machine axis of the turbomachine or of the guide vane cascade. In one embodiment, an adjusting load can be distributed in a particularly advantageous manner in this way.

According to one embodiment of the present invention, one or more, and preferably all, of these actuators (each) have a disconnection coupling.

In one embodiment, a power flow in a defective actuator can be disconnected in this way, so that, unlike in the initially named EP 3 101 279 A1, the defective actuator need not be braked. Additionally or alternatively, unlike in the initially named EP 3 101 279 A1, even in the case of a blocking (overall) drive of one actuator, the coupling ring can be adjusted by the remaining actuator or actuators. Additionally or alternatively, in one embodiment, the adjusting device can be constructed lightweight and/or compact in this way, in particular lightweight (more lightweight) and/or compact (more compact) than the one known from EP 3 101 279 A1.

In one embodiment, each of the guide vanes are or will be rotatable (when mounted) by rotating around a vane axis; in one embodiment, they are adjusted or rotated by rotating the coupling ring around an axis of rotation or main machine axis of the turbomachine, in particular by way of the vane lever mechanisms that are connected to the vanes and the coupling ring.

In this way, in one embodiment, an especially advantageous, in particular compact, lightweight, reliable, and/or precise, adjustment can be realized.

In one embodiment, one or a plurality of actuators (each) has or have a particularly electrical, preferably electromotive, hydraulic, and/or pneumatic drive; in one embodiment, the actuator(s) has or have one or a plurality of electric motors, preferably a stepper motor (stepper motors), and/or at least one gear, in particular a reduction gear, which converts a drive speed or gear input speed into a slower gear output speed or actuator output speed. In one embodiment, the gear has a Harmonic Drive gear and/or a reduction ratio of at least 1:50 and/or at most 1:200, and/or is a play-free gear, at least essentially. In one embodiment, the stepper motor has a step width of at least 0.5° and/or at most 5°. In one embodiment, the coupling ring or the adjusting device has an adjusting range or a range of rotation of at least 2.5° and/or at most 20°, and/or an adjusting accuracy of at least 2° and/or at most 0.01°.

In this way, in one embodiment, an especially advantageous, in particular (still) compact (more compact), lightweight (lighter-weight), reliable (more reliable), and/or precise (more precise) adjustment can be realized.

A disconnection coupling in the present case, particularly in the usual meaning in the art, is understood to be a device for interrupting a power flow, in particular a flow of torque inside the actuator or to the coupling ring, particularly during operation of the turbomachine. In other words, in one embodiment, an actuator or the drive thereof is or will be disengageable or disengaged or equipped or used for this purpose by opening the disconnection coupling from the coupling ring. In one embodiment, the disconnection coupling is arranged between the drive or gear and a drive output, in particular the actuator lever mechanism or a coupling of the particular actuator to the coupling ring.

In one embodiment, the coupling ring is or will be centered, in particular in a housing of the turbomachine, and/or by the at least three, in particular four or more, actuators, and spoke-centered in one embodiment. For this purpose, in one embodiment, the coupling ring is mounted radially displaceable on the actuators or the drive outputs thereof, in particular actuator lever mechanisms; in one embodiment, it is rotatable (in each case) around one or a plurality of axes, in particular by way of a sphere (in each case).

In one embodiment, the adjusting device can be constructed lightweight and/or compact in this way. Additionally or alternatively, mechanically and/or thermally induced loads can be balanced advantageously in this way.

In one embodiment, a disconnection coupling of one or of a plurality of actuators (in each case) is actively opened and/or closed, in particular electrically, hydraulically, or pneumatically; in one embodiment, by an adjustment means, in particular an electrically (activated), hydraulically (activated) or pneumatically (activated) adjustment means or is equipped for this purpose or will be used for this purpose.

Additionally or alternatively, in one embodiment, a disconnection coupling of one or a plurality of actuators (in each case) will be opened and/or closed load-free and/or under load or is equipped for this purpose or will be used for this purpose.

In one embodiment, loads can be distributed advantageously in this way, in particular variably, rapidly, and/or in a targeted manner, and/or defective drives can be selectively decoupled or disengaged.

In one embodiment, a load, in particular a torsional or bending load, and/or a tensile and/or compressive stress is detected by a load sensor in at least one coupling between one of the actuators and the coupling ring, in particular in the couplings between (the) at least two, in one embodiment at least three, in particular at least four, (of the) actuators and the coupling ring (in each case), or one or a plurality of load sensors is or are provided for this purpose, in particular is or are equipped or will be used for this purpose.

Additionally or alternatively, in one embodiment, a load, in particular a torque, will be detected by a load sensor in at least one of the actuators, in particular in (the) at least two, in one embodiment at least three, in particular at least four, (of the) actuators (in each case), or one or a plurality of load sensors is or are provided for this purpose, in particular is or are equipped or will be used for this purpose.

In this way, in one embodiment, (in each case) advantageously, a defect of an actuator can be detected, in particular, as stated above, in a statically overdetermined (spoke) centering with at least three or four actuators.

According to one embodiment of the present invention, two or more, preferably all, of the actuators, are controlled, in particular regulated, based on detected positions of the actuators and/or loads in the actuators, and/or couplings between the actuators and the coupling ring.

In one embodiment, loads can be balanced advantageously in this way.

Additionally or alternatively, at least one disconnection coupling of one of the actuators will be opened, if a predefined, in particular defective, state of this actuator is detected or prognosticated, in particular based on the detected position(s) of one or a plurality of the actuators and/or based on the detected load(s) in one or more of the actuators and/or in one or more of the couplings between the actuators and the coupling ring, in particular based on the detected position of the particular actuator or on the detected load in the particular actuator, or on the couplings between the particular actuator and the coupling ring.

For example, if a drive or a gear of one actuator is blocked when the disconnection coupling is closed, then a rotation of the coupling ring through the other actuators causes an (increasing or intense) strain in the coupling between the defective actuator and the coupling ring. Therefore, such a defective state can be detected by the corresponding load sensor and accordingly, the disconnection coupling can be opened.

In particular, as a consequence of a (nominal) adjustment of the guide vanes by the actuators, corresponding loads will take effect in the actuators or couplings. These loads in fact are dispersed among the individual actuators or couplings, and with a defect-free actuator, they lie within a specific tolerance range or a specific bandwidth. In contrast, in a defective actuator, such a load exceeds an (admissible) tolerance range or an (admissible) bandwidth.

Correspondingly, in one embodiment, a or the predefined state of an actuator will be detected (and correspondingly, the disconnection coupling thereof will be opened), if a detected load in this actuator and/or if a detected load in the coupling between this actuator and the coupling ring lies outside of a predefined tolerance region, in particular, lies outside a predefined tolerance region by a reference load, or exceeds a predefined tolerance range or a predefined bandwidth.

In one embodiment, the tolerance range can be or will be predefined empirically and/or on the basis of a simulation. In one embodiment, the reference load can be or will be predefined, particularly as a function of the theoretical and/or actual position and/or the theoretical and/or actual adjustment or travel path of the guide vanes, empirically and/or on the basis of a simulation, and/or based on a mean value of the detected loads, in particular of an average determined for the detected loads without consideration of outliers, in particular can or will correspond to such an average. The reference load can also be equal to zero. In one embodiment, a determination that does not consider outliers can be produced according to a statistical method, which is known in and of itself.

Therefore, in one embodiment, the disconnection coupling of an actuator will be opened, if a detected load in this actuator or a detected load in the coupling between this actuator and the coupling ring lies outside a predefined tolerance range or a predefined bandwidth or exceeds this (these). This decoupling is possible in a particularly advantageous manner in the case of a static overdetermination of the actuators.

In one embodiment, a defective, in particular a blocked or blocking, actuator or a predefined state or the predefined state of this actuator can also be detected on the basis of a change in the detected load(s), based on the detected position(s) and/or the change(s) thereof, and the disconnection coupling of this actuator can be opened in such a case.

Thus, for example, the disconnection coupling of an actuator can be opened, if the detected position (change in position) thereof deviates beyond a predefined admissible deviation from a nominal position (change in position), or a change in a detected load in this actuator or in the coupling between this actuator and the coupling ring deviates beyond a predefined admissible deviation from load changes in the other actuators. Correspondingly, in one embodiment, a predefined state or the predefined state of an actuator will be detected, and in an enhancement, the disconnection coupling thereof will be opened,
if a detected position of the actuator lies outside a predefined tolerance range, in particular a predefined tolerance range around a reference position; and/or
if a detected change in position of this actuator lies outside a predefined tolerance range, in particular a predefined tolerance range around a reference change in position; and/or
if a detected load in this actuator lies outside a predefined tolerance range, in particular a predefined tolerance range around a reference load; and/or
if a detected change in load in this actuator lies outside a predefined tolerance range, in particular a predefined tolerance range around a reference load change; and/or
if a detected load in this coupling between the actuator and the coupling ring lies outside a predefined tolerance range, in particular a predefined tolerance range around a reference load; and/or
if a detected change in load in the coupling between this actuator and the coupling ring lies outside a predefined tolerance range, in particular a predefined tolerance range around a reference load change.

According to one embodiment of the present invention, a control, in particular by hardware and/or software technology, is furnished for carrying out a method described here or a control of an adjusting device described here, and/or has means for controlling at least two of the actuators of the adjusting device based on detected positions of the actuators and/or loads in the couplings between the actuators and the coupling ring, and/or for opening at least one disconnection coupling of an actuator if a predefined state of this actuator is detected or prognosticated.

Correspondingly, in one embodiment, a control or its means has: a means for detecting a predefined state or the predefined state of an actuator, if a detected position and/or change in position of this actuator lies outside a predefined tolerance range, in particular of a predefined tolerance range around a reference position or a change in reference position, and/or if a detected load and/or a change in load in this actuator or in the coupling between this actuator and the coupling ring lies outside of a predefined tolerance range, particularly a predefined tolerance range around a reference load or a change in reference load.

In the sense of the present invention, a means can be designed technically by hardware and/or software, in particular, a data-associated or signal associated—especially a digital—processing unit (CPU), particularly a microprocessor, preferably with a memory system and/or a bus system, and/or can have one or a plurality of programs or program modules. The CPU can be designed for the purpose of executing commands that are implemented as a program filed in a memory system, to detect input signals from a data bus, and/or to deliver output signals to a data bus. A memory system can have one or more, in particular different, memory media, in particular optical, magnetic, hard drive, and/or other non-volatile media. The program can be created in such a way that it is incorporated in or is able to execute the method described here, so that the CPU can execute the steps of such a method, and thus, in particular, can control the adjusting device.

In one embodiment, one or more, in particular all, steps of the method are conducted completely or partially automated, in particular by the control or the means thereof.

### BRIEF DESCRIPTION OF THE DRAWING FIGURES

Additional advantageous enhancements of the present invention can be taken from the dependent claims and the following description of preferred embodiments. For this purpose and partially schematized:

FIG. 1 shows a guide vane cascade of a turbomachine having an adjusting device according to one embodiment of the present invention;

FIG. 2 shows an actuator of the adjusting device; and

FIG. 3 shows a method for controlling the adjusting device according to one embodiment of the present invention.

### DESCRIPTION OF THE INVENTION

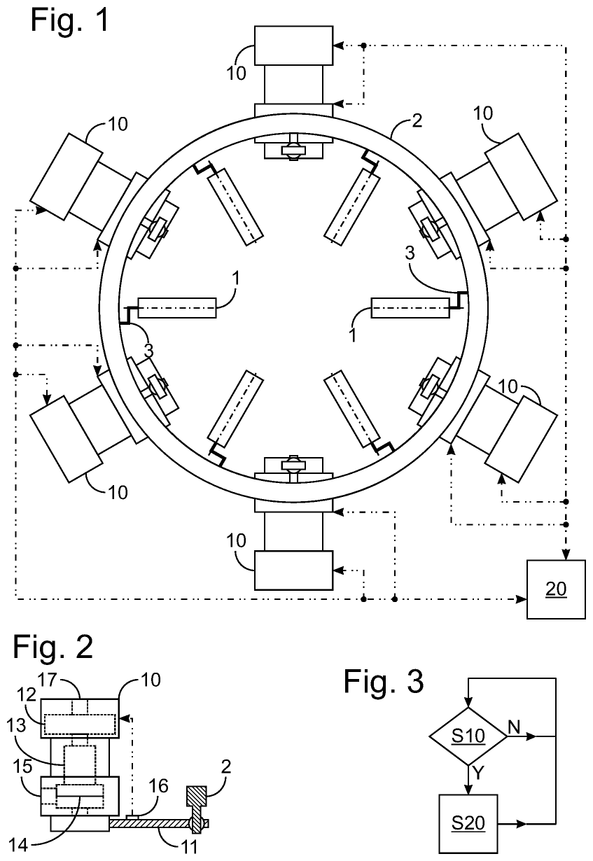

FIG. 1 shows a guide vane cascade of a turbomachine having an adjusting device in order to adjust guide vanes 1 of the guide vane cascade of the turbomachine according to one embodiment of the present invention, wherein the adjusting device comprises a coupling ring 2, to which the guide vanes 1 are coupled by vane lever mechanisms 3 in such a way that a rotation of the coupling ring 2 around a (main) machine axis of the turbomachine (perpendicular to the plane of the drawing of FIG. 2) rotates the guide vanes 1 around their vane longitudinal axes (dot-dash lines in FIG. 1), and six actuators 10 for rotating the coupling ring 2, these actuators being connected to the coupling ring via actuator lever mechanisms 11, and are arranged in a housing (not shown).

Each of the actuators 10, which have at least essentially the same structure, comprises an electrical drive motor 12, a play-free reduction gear 13 and a disconnection coupling 14, which can be actively opened by an adjustment means 15 both under load and also when load-free.

The coupling ring 2 is spoke centered by the six actuators 10, and for this purpose is mounted displaceable radially and spherically on the actuator lever mechanisms 11 thereof.

In each case, a load sensor 16 with at least one DMS is arranged on the actuator lever mechanism 11, in order to detect a load in the coupling between the particular actuator and the coupling ring.

A control 20 redundantly controls the actuators 10 based on positions of the actuators detected by means of rotation sensors 17, and loads in the couplings between the actuators and the coupling ring by means of load sensors 16, in particular based on a comparison of the positions and loads.

Due to the static overdetermination of the spoke centering, in this case, the control 20 can detect blocked drives and in this case, i.e., if a defective state of the actuator is detected (S10: “Y”), it opens the disconnection coupling thereof in a step S20 of a method for controlling the adjusting device according to one embodiment of the present invention.

For this purpose, in step S10, the control 20 checks whether one or more of the detected loads lies (lie) outside a predefined tolerance range or a predefined bandwidth, in this case detects the one or more corresponding drive(s) as blocked or defective, and correspondingly opens the disconnection coupling(s) belonging thereto.

Although exemplary embodiments were explained in the preceding description, it shall be noted that a plurality of modifications is possible. In addition, it shall be noted that the exemplary embodiments only involve examples that in no way shall limit the scope of protection, the applications, and the construction. Rather, a guide is given to the person skilled in the art by the preceding description for implementing at least one exemplary embodiment, whereby diverse changes, particularly with respect to the function and arrangement of the described components, can be carried out without departing from the scope of protection, as it results from the claims and combinations of features equivalent to these.

1. An adjusting device for adjusting guide vanes of a guide vane cascade of a turbomachine, wherein the adjusting device comprises a coupling ring for coupling the guide vanes and at least two actuators for rotating the coupling ring, said actuators being connected to the coupling ring, wherein at least one of these actuators has a disconnection coupling.

2. The adjusting device according to claim 1, wherein the adjusting device comprises at least three actuators for rotating the coupling ring, the actuators being connected to the coupling ring, wherein at least one of these actuators has a disconnection coupling.

3. The adjusting device according to claim 2, wherein the adjusting device comprises four or more actuators for rotating the coupling ring, the actuators being connected to the coupling ring, wherein at least one of these actuators has a disconnection coupling.

4. The adjusting device according to claim 1, wherein the coupling ring is centered, spoke-centered, in a housing of the turbomachine, and/or by the at least three actuators.

5. The adjusting device according to claim 1, wherein at least one disconnection coupling of an actuator can be opened and/or can be closed actively by electricity, hydraulics or pneumatics and/or being configured load-free and/or under load.

6. The adjusting device according to claim 1, wherein at least one load sensor for detects a load in one of the actuators or in a coupling between one of the actuators and the coupling ring.

7. The adjusting device according to claim 1, wherein the adjusting device is configured and arranged to adjust a plurality of guide vanes in a guide vane cascade for a turbomachine.

8. The adjusting device according to claim 7, wherein at least one guide vane cascade is provided in the turbomachine.

9. The adjusting device according to claim 7, wherein at least two of the actuators of the adjusting device are controlled based on detected positions of the actuators and/or loads in the actuators and/or in the couplings between the actuators and the coupling ring, and/or in that at least one disconnection coupling of one actuator will be opened if a predefined state of this actuator is detected or prognosticated.

10. The adjusting device according to claim 9, wherein a predefined state of this actuator is detected, if a detected position and/or change in position of this actuator and/or a detected load and/or change in load in this actuator and/or the coupling between this actuator and the coupling ring lies outside a predefined tolerance range.

11. The adjusting device according to claim 7, wherein at least two of the actuators of the adjusting device based on detected positions of the actuators and/or loads in the couplings between the actuators and the coupling ring, and/or for opening at least one disconnection coupling of an actuator, if a predefined state of this actuator is detected or prognosticated.
